(19) United States
(12) Patent Application Publication
(10) Pub. No.: US 2016/0333890 A1
(43) Pub. Date: Nov. 17, 2016

(54) GAS TURBINE ENGINE INNER CASE WITH NON-INTEGRAL VANES

(71) Applicant: UNITED TECHNOLOGIES CORPORATION, Farmington, CT (US)

(72) Inventors: Richard K. Hayford, Cape Neddick, ME (US); Mark J. Rogers, Kennebunk, ME (US); Carl S. Richardson, South Berwick, ME (US); Jonathan J. Earl, Wells, ME (US)

(21) Appl. No.: 15/110,856

(22) PCT Filed: Dec. 26, 2014
(86) PCT No.: PCT/US2014/072434

§ 371 Date: Jul. 11, 2016

Related U.S. Application Data
(60) Provisional application No. 61/931,161, filed on Jan. 24, 2014.

(51) Int. Cl. F04D 29/54; F04D 29/52; F04D 29/64

(52) U.S. Cl. CPC F04D 29/542; F04D 29/644; F04D 29/522; F05B 2220/302; F05B 2240/124; F05B 2280/50032; F05B 2280/10743

(57) ABSTRACT

A gas turbine engine includes a circumferential array of vanes slidably supported in an inner case shroud segment. Multiple segments are secured to one another to provide an annular engine static structure section. The inner case shroud segment and the vanes have different material properties than one another.

### CROSS-REFERENCE TO RELATED APPLICATIONS

This application claims priority to U.S. Provisional Application No. 61/931,161, which was filed on Jan. 24, 2014 and is incorporated herein by reference.

### STATEMENT REGARDING FEDERALLY SPONSORED RESEARCH OR DEVELOPMENT

This invention was made with government support with the United States Air Force under Contract No.: FA8650-09-D-2923 0021. The government therefore has certain rights in this invention.

### BACKGROUND

This disclosure relates to an inner case structure for a gas turbine engine and, more particularly, an assembly of the inner case shroud and vanes.

Gas turbine engines generally include fan, compressor, combustor and turbine sections along an engine axis of rotation. The fan, compressor, and turbine sections each include a series of stator and rotor blade assemblies. A rotor and an axially adjacent array of stator assemblies may be referred to as a stage. Each array of stator vanes increases efficiency through the direction of core gas flow into or out of the rotor assemblies.

Engine static structures for the compressor section of military gas turbine engines may use arcuate segments secured to one another to provide a circular inner case shroud. Such segments typically contain multiple axially arranged rows of vanes. The segments are assembled around the compressor rotor stages with the blades already installed.

In prior segmented shrouds, the vanes have been rigidly attached by welding, brazing or unified casting to the inner case shroud at the outer flow path diameter of the compressor section. These rigidly attached blades may experience high vibratory stresses.

### SUMMARY

In one exemplary embodiment, a gas turbine engine includes a circumferential array of vanes slidably supported in an inner case shroud segment. Multiple segments are secured to one another to provide an annular engine static structure section. The inner case shroud segment and the vanes have different material properties than one another.

In a further embodiment of the above, the annular engine static structure section is a compressor section.

In a further embodiment of any of the above, the compressor section is a high pressure compressor section.

In a further embodiment of any of the above, the inner case shroud segment includes at least two rows of vanes axially spaced from one another.

In a further embodiment of any of the above, the two rows of vanes have different properties than one another.

In a further embodiment of any of the above, the inner case shroud segment includes an arcuate groove arranged axially between the two rows of vanes. A material is adhered to the inner case shroud segment within the arcuate groove.

In a further embodiment of any of the above, an upstream row of vanes includes a lower strength nickel alloy than a downstream row of vanes.

In a further embodiment of any of the above, the annular inner case shroud includes an arcuate slot. The vanes include hooks that are received in the arcuate slots.

In a further embodiment of any of the above, a damper or a wear liner is arranged in the annular slot between the hooks and the inner case shroud segment.

In a further embodiment of any of the above, the different material properties include different coefficients of thermal expansion.

In a further embodiment of any of the above, the different material properties include different fatigue strengths.

In a further embodiment of any of the above, the different material properties include different manufacturing processes. The inner case shroud segment is cast and the vanes are forged.

In another exemplary embodiment, a compressor section of a gas turbine engine includes a circumferential array of vanes slidably supported in an inner case shroud segment. Multiple segments are secured to one another to provide an annular engine static structure section. The inner case shroud segment and the vanes have different material properties than one another. The inner case shroud segment includes at least two rows of vanes axially spaced from one another.

In a further embodiment of the above, the two rows of vanes have different properties than one another.

In a further embodiment of any of the above, the two rows of vanes have different properties than one another.

In a further embodiment of any of the above, the inner case shroud segment includes an arcuate groove arranged axially between the two rows of vanes. A material is adhered to the inner case shroud segment within the arcuate groove.

In a further embodiment of any of the above, an upstream row of vanes includes a lower strength nickel alloy than a downstream row of vanes.

In a further embodiment of any of the above, the annular inner case shroud includes an arcuate slot. The vanes include hooks received in the arcuate slots. A damper is arranged in the annular slot between the hooks and the inner case shroud segment.

In a further embodiment of any of the above, the compressor section is a high pressure compressor section.

In a further embodiment of any of the above, the different material properties include at least one of different coefficients of thermal expansion, different material, different fatigue strengths, or different manufacturing processes.

### BRIEF DESCRIPTION OF THE DRAWINGS

The disclosure can be further understood by reference to the following detailed description when considered in connection with the accompanying drawings wherein:

FIG. 1 is a highly schematic view of an example turbojet engine.

FIG. 2 is a schematic view of a compressor section of an example engine.

FIG. 3 is a schematic view of the compressor section with multiple arcuate segments.

FIG. 4 is a perspective view of the segment shown in FIG. 3 with slidably supported vanes.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

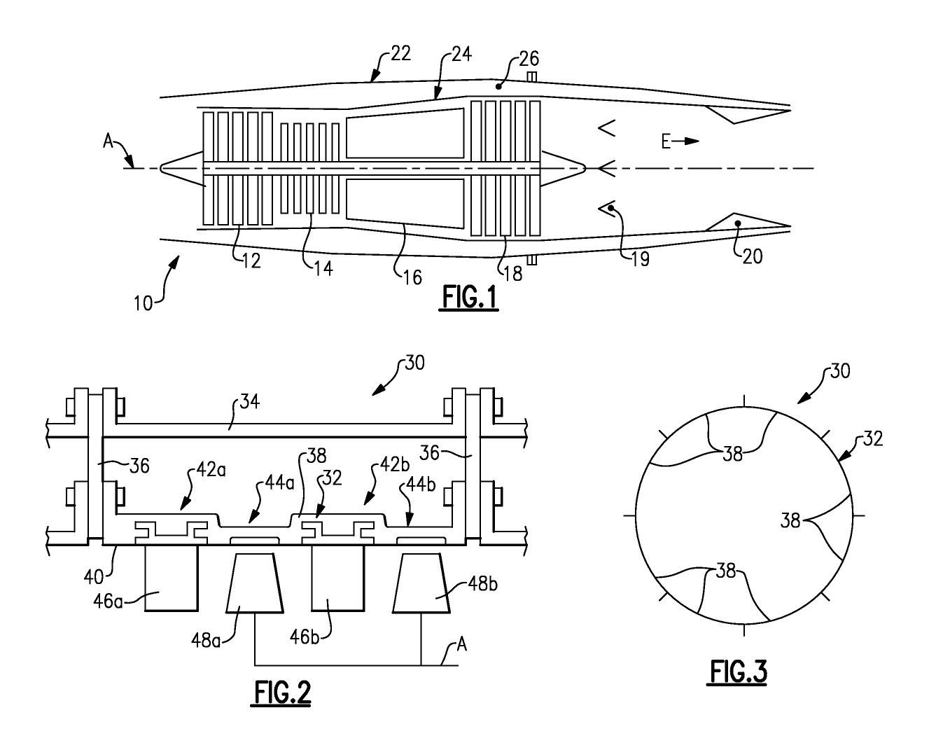

FIG. 1 illustrates an example turbojet engine 10. The engine 10 generally includes a fan section 12, a compressor section 14, a combustor section 16, a turbine section 18, an augmentor section 19 and a nozzle section 20. The compressor section 14, combustor section 16 and turbine section 18 are generally referred to as the core engine. An axis A of the engine 10 extends longitudinally through the sections. An outer engine duct structure 22 and an inner cooling liner structure 24, or exhaust liner, provide an annular secondary fan bypass flow path 26 around a primary exhaust flow path E.

While a military engine is shown, the disclosed inner case shroud and vane assembly may be used in commercial and industrial gas turbine engines as well. The examples described in this disclosure is not limited to a single-spool gas turbine and may be used in other architectures, such as a two-spool axial design, a three-spool axial design, and still other architectures. That is, there are various types of gas turbine engines, and other turbomachines, that can benefit from the examples disclosed herein.

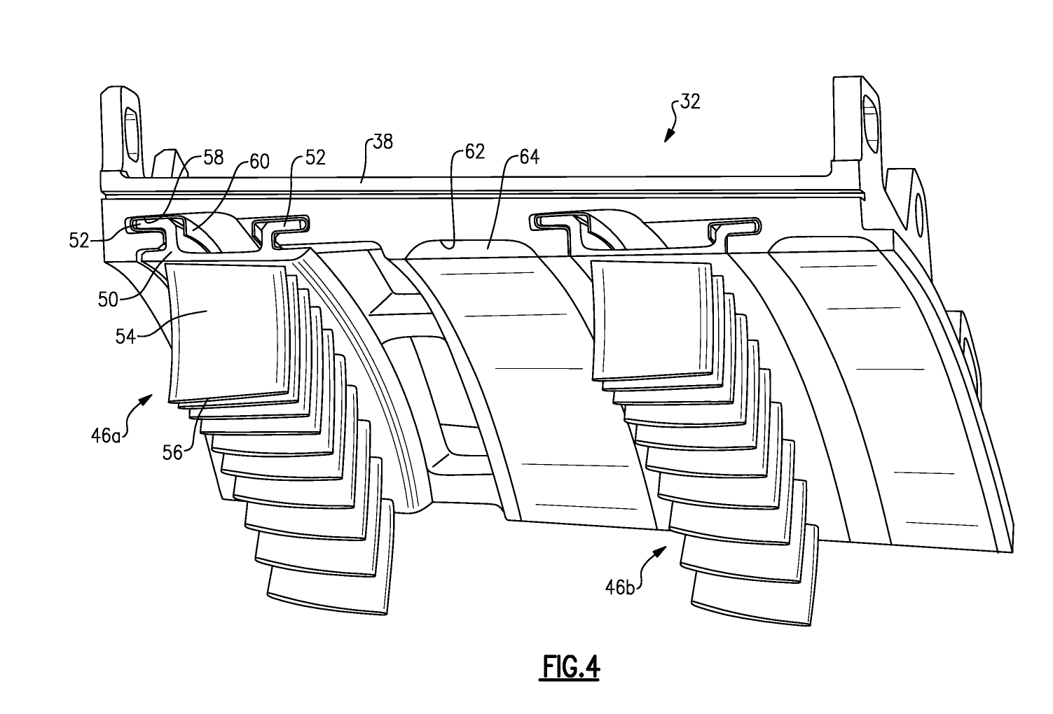

The example compressor section 14 includes engine static structure 30, which has an inner case shroud 32 secured to an outer case 34. In the example, the inner case shroud 32 is provided by multiple arcuate segments 38 secured to one another to provide an annular section, as shown in FIG. 3.

Returning to FIG. 2, the segments 38 are secured to one another by rings 36. The inner case shroud 32 provides an outer flow path surface 40. Multiple fixed stages 42a, 42b and multiple rotatable stages 44a, 44b are provided in the compressor section 14, in the example, two rows of each. Fewer or greater number of fixed and/or rotating stages may be used than depicted, if desired. In the example, the stages are arranged in a high pressure compressor portion of the compressor section 14, immediately upstream of the combustor section 16.

The rotatable stages 44a, 44b respectively include circumferential arrays of blades 48a, 48b for rotation about the axis A. The fixed stages 42a, 42b respectively included circumferential arrays of vanes 46a, 46b. Referring to FIGS. 2 and 4, the inner case shroud 32 includes an arcuate groove 62 arranged axially between the two rows of vanes 46a, 46b and radially outward of each array of blades 48a, 48b. Material 64 is adhered to the inner case shroud 32 within the arcuate grooves 62.

Referring to FIG. 4, the vanes 46a, 46b are slidably supported in the inner case shroud 32. The vanes may be individual with discrete airfoils 54, or clusters of airfoils sharing a common outer platform 50. In the example, the vanes are of the cantilevered type with free inner ends 56. The inner case shroud 32 and the vanes 46a, 46b have different material properties than one another.

The inner case shroud 32 includes arcuate slots 58. The vanes 46a, 46b include hooks 52 received in the arcuate slots 58. A damper or wear liner 60 is arranged in each of the annular slots 58 between the hooks 52 and the inner case shroud 32.

In one example, the two rows of vanes 46a, 46b have different properties than one another. For example, the upstream row of vanes 46a includes a lower strength nickel alloy than the downstream row of vanes 46b. In another example, the different material properties include different coefficients of thermal expansion. In other examples, the different material properties include different fatigue strengths and/or different manufacturing processes.

The non-integrated inner case shroud and vane assembly enables material combinations for the vanes relative to the segments 38, which can provide an overall lighter inner case shroud. For example, a higher strength forged material alloy could be used for the vanes, and a lower cost cast alloy could be used for the inner case shroud segments. Higher strength material alloy may enable the use of individual or clustered vanes. Similarly, the inner case shroud segments could be made of a different material alloy than the vanes. This could be to optimize relative thermal growth of the inner case shroud to minimize blade and vane tip clearance changes relative to the adjacent rotor structure, while retaining a higher fatigue strength material alloy for the vanes. The inner case shroud segment arc length can be altered for part cost and manufacturing considerations, compressor blade or vane clearance and performance considerations and engine assembly considerations. The inner case shroud segment allows slidably supported vanes providing mechanical damping on the vane airfoil vibration for improved structural durability.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A gas turbine engine comprising:
a circumferential array of vanes slidably supported in an inner case shroud segment, multiple segments secured to one another to provide an annular engine static structure section, the inner case shroud segment and the vanes having different material properties than one another.

2. The gas turbine engine according to claim 1, wherein the annular engine static structure section is a compressor section.

3. The gas turbine engine according to claim 2, wherein the compressor section is a high pressure compressor section.

4. The gas turbine engine according to claim 1, wherein the inner case shroud segment includes at least two rows of vanes axially spaced from one another.

5. The gas turbine engine according to claim 4, wherein the two rows of vanes have different properties than one another.

6. The gas turbine engine according to claim 5, wherein inner case shroud segment includes an arcuate groove arranged axially between the two rows of vanes, and a material is adhered to the inner case shroud segment within the arcuate groove.

7. The gas turbine engine according to claim 5, wherein an upstream row of vanes includes a lower strength nickel alloy than a downstream row of vanes.

8. The gas turbine engine according to claim 1, wherein the annular inner case shroud includes an arcuate slot, and the vanes include hooks received in the arcuate slots.

9. The gas turbine engine according to claim 7, comprising a damper or a wear liner arranged in the annular slot between the hooks and the inner case shroud segment.

10. The gas turbine engine according to claim 1, wherein the different material properties include different coefficients of thermal expansion.

11. The gas turbine engine according to claim 1, wherein the different material properties include different fatigue strengths.

12. The gas turbine engine according to claim 1, wherein the different material properties include different manufacturing processes, and wherein the inner case shroud segment is cast and the vanes are forged.

13. A compressor section of a gas turbine engine, comprising:
a circumferential array of vanes slidably supported in an inner case shroud segment, multiple segments secured to one another to provide an annular engine static structure section, the inner case shroud segment and the vanes having different material properties than one another, the inner case shroud segment includes at least two rows of vanes axially spaced from one another.

14. The compressor section according to claim 13, wherein the two rows of vanes have different properties than one another.

15. The compressor section according to claim 14, wherein the two rows of vanes have different properties than one another.

16. The compressor section according to claim 15, wherein inner case shroud segment includes an arcuate groove arranged axially between the two rows of vanes, and a material is adhered to the inner case shroud segment within the arcuate groove.

17. The compressor section according to claim 14, wherein an upstream row of vanes includes a lower strength nickel alloy than a downstream row of vanes.

18. The compressor section according to claim 13, wherein the annular inner case shroud includes an arcuate slot, and the vanes include hooks received in the arcuate slots, and a damper is arranged in the annular slot between the hooks and the inner case shroud segment.

19. The compressor section according to claim 13, wherein the compressor section is a high pressure compressor section.

20. The compressor section according to claim 13, wherein the different material properties include at least one of different coefficients of thermal expansion, different material, different fatigue strengths, or different manufacturing processes.
